(19) United States
(12) Patent Application Publication
(10) Pub. No.: US 2012/0030230 A1
(43) Pub. Date: Feb. 2, 2012

(54) Method and System for Gathering and Pseudo-Objectively Classifying Copyrightable Material to be Licensed Through a Provider Network

(76) Inventors: Eric Sheinkop, Los Angeles, CA (US); Jonathan Sheinkop, Chicago, IL (US); John Williamson, Chicago, IL (US); Tim Lincoln, Brooklyn, NY (US); Dan Kuypers, Chicago, IL (US); Joshua Burke, Chicago, IL (US)

(21) Appl. No.: 12/844,773

(22) Filed: Jul. 27, 2010

(51) Int. Cl. G06F 3/01; G06F 17/30

(52) U.S. Cl. 707/769; 715/716; 707/E17.014

(57) ABSTRACT

Disclosed is a method and system for gathering and pseudo-objectively classifying copyrightable material so as to facilitate identification of selected copyrightable material for licensing through a provider network. More particularly, disclosed is an end-to-end system and method that facilitates the licensing or sale of an author's copyrighted work(s) to third parties through a database of copyrighted works accessible to such users, such database being searchable based on certain predetermined criteria to allow the buyer/licensee to efficiently search for the desired genre or style of artwork for a given purpose. Also disclosed is a system and method of providing users with customized content lists (such as musical playlists, visual artwork lists, or textual copylists) based on subjective criteria that are objectivized using predetermined quality control guidelines.

### FIELD OF THE INVENTION

The invention relates to a method and system for gathering and pseudo-objectively classifying copyrightable material so as to facilitate identification of selected copyrightable material for licensing through a provider network. More particularly, the invention relates to gathering copyrightable materials via a provider network, classifying such copyrightable material based on subjective criteria, attributes or other descriptors that are made substantially objective through the use of dynamically developed categories supported by dynamically developed guidelines, and then making such classified copyrightable material available for licensing to third parties through the provider network.

### BACKGROUND

Licensees of copyrightable materials (such as by way of example, advertisers, advertising agencies, film producers and gaming companies), frequently use copyrightable materials to set a mood or even just provide a pleasant background for their advertisement, video scene, or web-based presentations. Finding the “right” audio, video or image can be a time consuming and expensive process. And once that “right” piece is found, substantial time may have to be expended in negotiating and obtaining a license to such copyrighted material.

There is a need in the industry to streamline the process surrounding selection and distribution (such as through licensing or sale) of copyrightable materials. As part of this streamlining process, proper and consistent classification of copyrightable materials is important so time is not wasted considering works that are not appropriately classified.

For the little-known “starving artist,” being able to generate revenue from their works, be it music, written text or visual artwork, can be a difficult if not nearly impossible undertaking. One hurdle is that potential buyers or licensees prefer to use copyrighted materials from established artists to reduce the risk of potential copyright infringement claims. In addition, when a licensee or potential licensee is looking for a certain genre or style of copyrighted work, that individual or entity is likely to look toward artists that are already familiar with in that genre or style.

There are a number of different musical classification systems and applications in existence. For example, the iTunes® store allows users to search for music using a plurality of criteria, including artist, composer, album and genre. Similarly, the Music Genome Project® (on which Pandora® Radio was based) was formed to “capture the essence of music at the fundamental level” using almost 400 attributes to describe songs and a complex mathematical algorithm to organize them. Similarly, MusicBrainz is a user-maintained open community that collects, and makes available to the public, music metadata in the form of a relational database. The metadata collected includes artist data, type, annotations, duration, release information and the like.

One disadvantage with the classification of music in each of these existing systems or applications is the lack of a mechanism for maximizing uniformity and consistency of classifying music within a database. In U.S. Pat. No. 7,279,629 (“the '629 patent”), the desirability to review classifications of music according to certain quality control criteria is disclosed. In particular, the '629 patent teaches that once a first reviewer has created and stored classification values for a song, a second reviewer may review the song and the stored classification values to improve uniformity and consistency. Unfortunately this quality-control procedure is linear and must be done on a song-by-song basis. Further, there are no procedures put into place to ensure that mis-classifications do not occur in the future, nor is there any quality control protocol to determine whether the second reviewer's subjective view is more “accurate” than the first reviewer's subjective view. Moreover, the classification values themselves are not themselves adaptable.

Accordingly, there is a need in the industry to provide lesser-known artists with an outlet for their copyrightable works. There is an associated need to make particularized copyrightable works easier to match to previously conceived production opportunities. There is also a need in the industry to create a system for pseudo-objectively classifying copyrightable materials based on concrete adaptable classification protocols.

These and other needs are met by the present method and system as will be understood by those of ordinary skill in the art having the present specification before them.

### BRIEF DESCRIPTION OF THE INVENTION

Disclosed is a system for facilitating the selection of music comprising a provider network having a first system interface, a second system interface, and a server, wherein the first and second system interfaces are operably connected to the server; a music database associated with the provider network containing a plurality of songs; and a playlist stored in association with the provider network, the playlist populated with one or more songs selected from the music database via the first system interface, wherein the provider network is configured to allow substantially simultaneous accessed to the playlist by the first and second user interfaces; wherein the playlist provides notice to the second user interface of modification made to the playlist via the first user interface.

The system may further comprise a search module configured to search the music database and provide a resulting list of songs associated with a first classification, and means for selecting a first song from the resulting list of songs to populate the playlist via the first system interface. The first classification may be selected from the group consisting of vocal, instrumental, genre, secondary genre, mood, vocal type, explicit lyrics, instrument, keyword, description, vocal theme, language, beats per minutes, duration, time signature, key, era, artist, song title, and album title. The system may also be associated with a second classification, such that the first classification may genre, and the second classification may be selected from the group consisting of: americana, blues, cajun zydeco, children, classical, comedy, country, disco, easy listening, electronic, exotica, fanfares, marches, folk, funk, holiday, special occasion, international, jazz, Latin, lounge, new age, pop, reggae, religious, rock, singer-songwriter, solo instrument, spoken word, urban, and world beat.

Also disclosed is a system for facilitating the selection of music comprising: a provider network having a first system interface, a second system interface, and a server, wherein the first and second system interfaces are operably connected to the server; a music database associated with the provider network containing a plurality of songs; a playlist stored in association with the provider network, the playlist populated with one or more songs selected from the music database via the first system interface, wherein the provider network is configured to allow substantially simultaneous accessed to the playlist by the first and second system interfaces; and means for creating a customized visual appearance for the playlist via the provider network. The system may further include means for providing access to the customized playlist to a third party via a third system interface.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1A illustrates a system for gathering and pseudo-objectively classifying copyrightable material from artists so as to facilitate identification of selected copyrightable material for licensing to members through a provider network, in accordance with an example implementation of one embodiment of the invention.

FIG. 1B illustrates an ongoing process of gathering and pseudo-objectively classifying songs from artists, to facilitate identification of selected copyrightable material for licensing to members through a provider network, in accordance with an example implementation of the invention.

FIG. 2 illustrates a meeting process for adapting classification protocols so as to maximize consistency, reliability and uniformity in classifying songs, in accordance with one embodiment of the invention.

FIG. 3 illustrates an example implementation of a potential reviewer test/evaluation procedure in accordance with an implementation of the invention.

FIG. 4 illustrates an example of a playlist generated in connection with the disclosed invention.

FIG. 5 illustrates an example navigation bar shown via a GUI of a system interface.

FIG. 6 illustrates a GUI screen requesting that a playlist title be entered.

FIG. 7 illustrates a GUI screen at which general information relating to a playlist may be entered.

FIG. 8 illustrates a GUI screen at which specific editing or use rights for a given playlist may be entered.

FIG. 9 illustrates a screen shot showing a drop down menu of particular jobs or projects.

FIG. 10 illustrates a playlist contact information screen shot.

FIG. 11 illustrates a search screen including a plurality of filter options, with a list of search results based on the selected filter options.

FIG. 12 illustrates a playlist editing screen.

FIG. 13 illustrates a screen shot of a deal board on a provider's website.

FIG. 14 illustrates a portion of the deal board of FIG. 13 with one of the deals in the list expanded to show details.

FIG. 15 illustrates an example of an artist profile.

FIG. 16 illustrates an example of one page of a classification protocol for the rock genre.

FIG. 17 illustrates an example implementation of the customization of the design of a playlist.

FIG. 18 illustrates one example of a GUI for provider personnel in connection with the invention.

### DETAILED DESCRIPTION OF THE INVENTION

While the present disclosure may be embodied in many different forms, the drawings and discussion are presented with the understanding that the present disclosure is an exemplification of the principles of one or more inventions and is not intended to limit any one of the inventions to the embodiments illustrated.

While the present invention may be applied in the context of selection and distribution of any type of copyrightable material, including visual works (such as graphic designs, paintings, sculptures, architecture, clip art, performance rights, etc.), textual works (such as fiction, non-fiction, poetry, written screenplays), and audio works, in order to facilitate description of the novel aspects of the present system and method, the detailed description provided herein describes the preferred implementation of the invention in connection with the selection and distribution of musical works of authorship (referred to herein simply as “musical works” or “songs”). The term “distribution” when used generally herein in connection with a copyrightable work shall include distribution by any means, including the contractual licensing and/or sale thereof.

The term “classify” or “classification” may generally refer to any type or category of classification for copyrightable works, including without limitation genre, sub-genre, secondary genre, mood, type, keyword, description, language, era, key, color scheme, culture, nationality, fiction/non-fiction, vocal/instrumental, medium, actual/intended message, subject matter, and style. It should be understood that this list is not exhaustive, but merely representative of the types of classifications that may apply to copyrightable works.

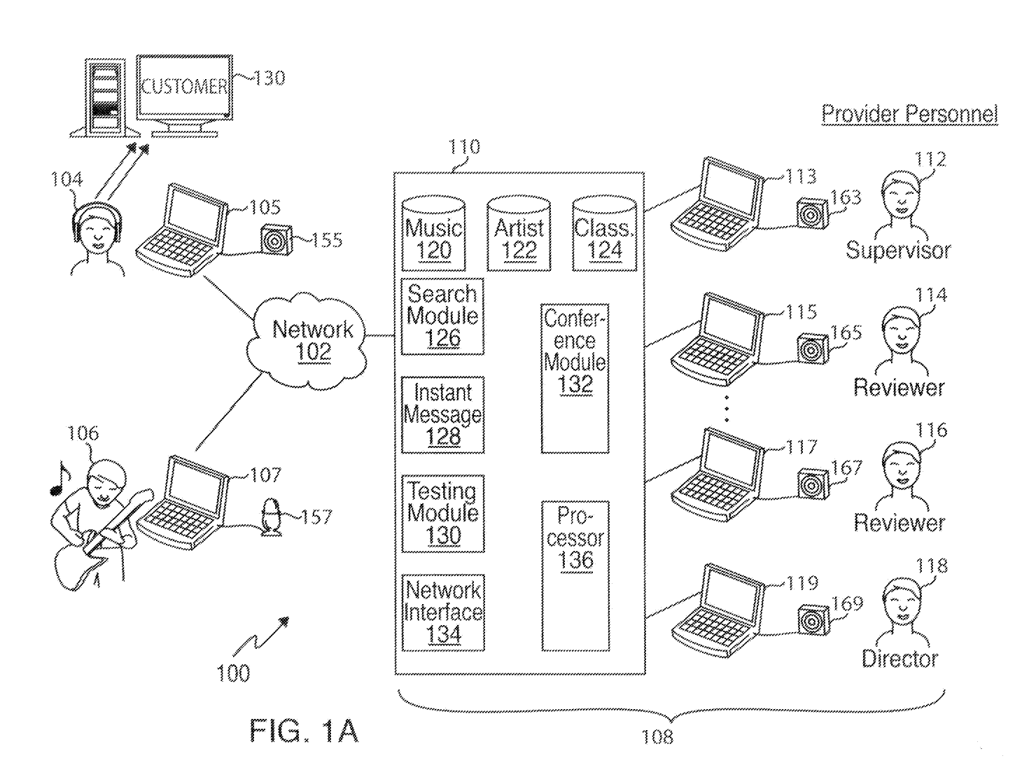

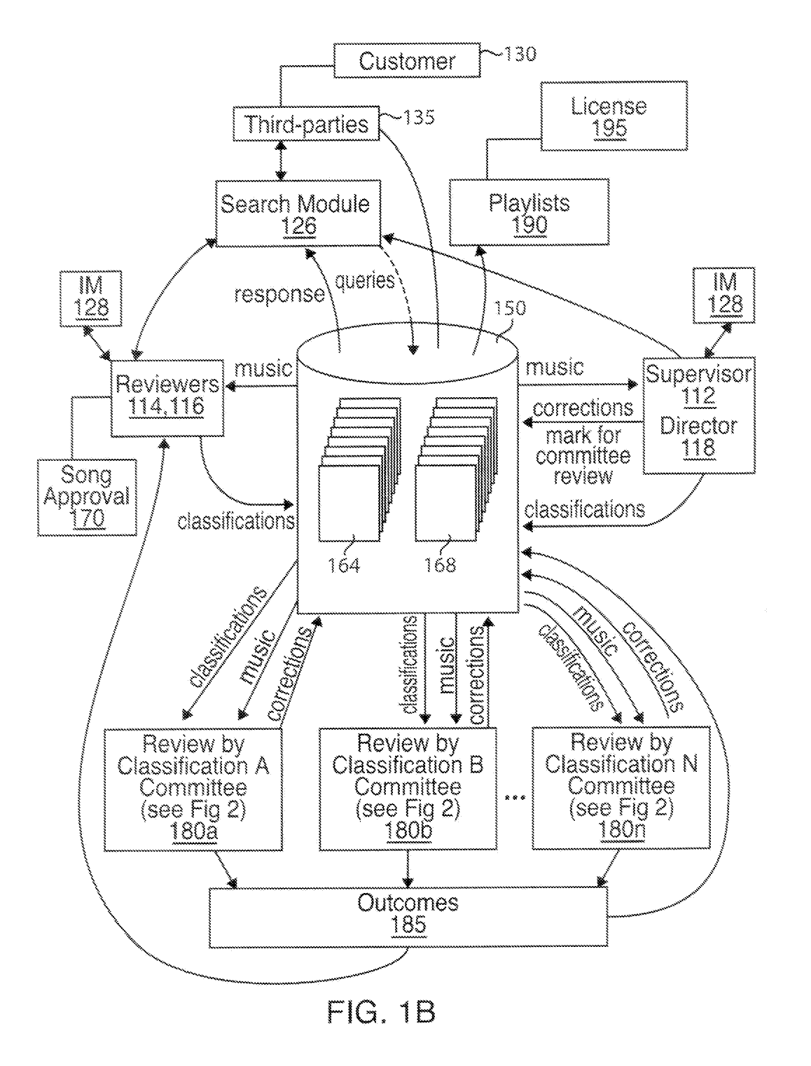

FIG. 1A illustrates a system 100 for gathering and pseudo-objectively classifying copyrightable material from one or more artists 106 so as to facilitate identification of selected copyrightable material for licensing to members 104 through a provider network 108, in accordance with one implementation of the invention. As explained, while the classified and licensed material may include any copyrightable material, including video, images or music, for ease of description, the particular embodiment illustrated in the Figures will be described in the context of classifying and licensing music.

The pseudo-objective classification of music (copyrightable material), which will be described in greater detail below, may be done by or on behalf of a service provider (or simply “provider”) (not shown) through a provider network 108. The provider network 108 includes one or more servers 110, on which a music database 120, an artist profile database 122 and a classification database 124 are stored. Each of the databases 120, 122, 124 may be individual databases or combined into a single database. The server 110 also includes a search module 126, an instant messaging module 128, a testing module 130 and a conferencing module 132. It will be understood by one of ordinary skill in the art that all the databases and modules may reside on a single server 110 as shown in FIG. 1A, or some may reside on different servers. It will also be understood that—aside from potential security concerns—one or more of the modules and/or databases may be operating and/or stored “in the cloud.” Further, while the server 110 is shown as part of the provider network 108, one or more of the databases or modules described herein may reside on a third party server or a member's or artist's own PC 105, 107 or network. For example, the search module 126 may be downloaded onto the member's PC 105.

The search module 126 is a software application through which provider personnel (112, 114, 116, 118), artists 106, members 104 and/or other third parties may search the music database using pseudo-objective classifications. As explained below, the pseudo-objective classifications are preferably memorialized in one or more dynamically developed classification protocols stored in the classification database 124. These classification protocols generally describe, define or otherwise explain the various pseudo objective classifications based on descriptors, definitions, annotations, attributes and informational links (collectively, “descriptors”), which are adaptable as described herein.

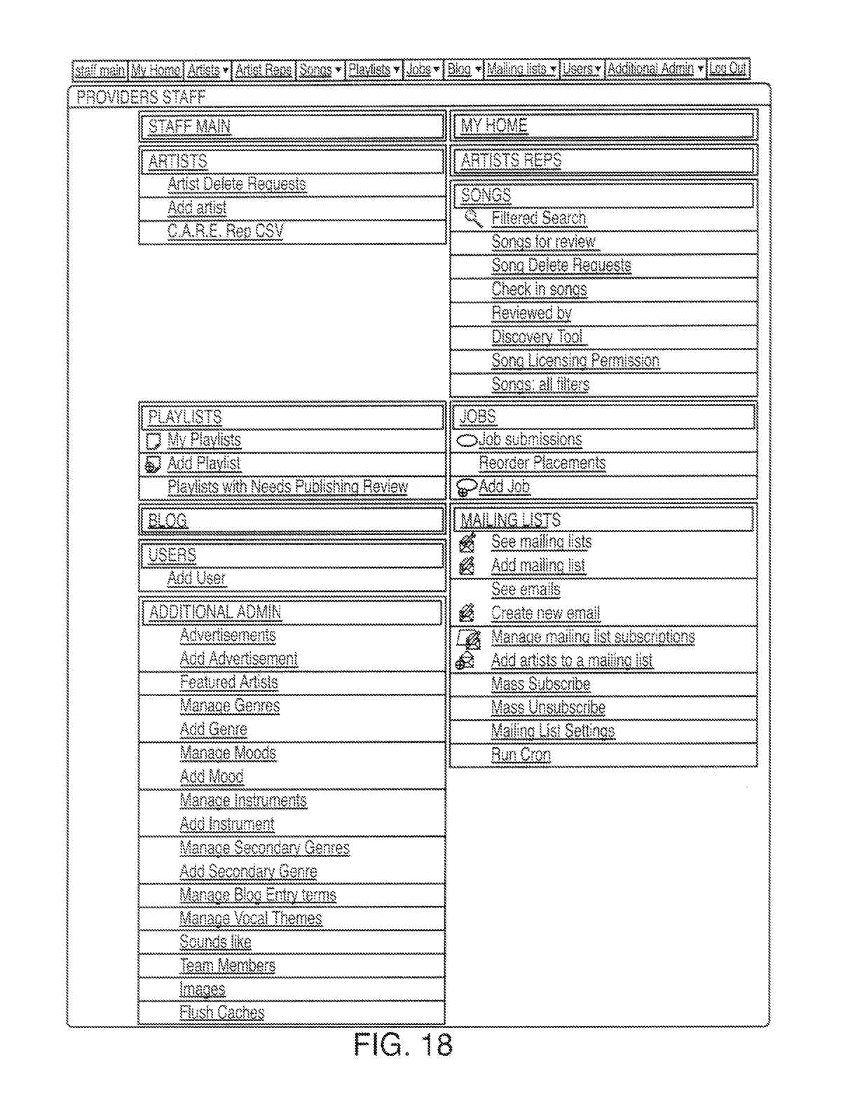

Each provider personnel (112, 114, 116, 118), artist 106 and member 104 may access the server 110 by any known means, including via a PC, mobile communication device or other network or server interface (105, 107, 113, 115, 117, 119), any of which may have a mouse, keyboard or other known interface means (generally referred to as a system interface), any of which preferably includes a graphical user interface (“GUI”). FIG. 18 illustrates one example of a GUI for provider personnel in connection with the invention.

Each system interface (105, 107, 113, 115, 117, 119) preferably includes an audio speaker or headphones (155, 163, 165, 167, 169) configured to output audio from a digital audio player (not shown) on the respective system interfaces. In addition, the artist's system interface 107 may include a microphone 157 to allow direct storage of musical works for uploading to the server 110. Various digital audio players may be used in association with system 100, including, but not limited to Microsoft Media Player. Individuals may use the search module 126 to query the music database 120 according to select criteria. Functionality and features of the search module 126 will be described in greater detail below.

The artist profile database 122 includes profile information relating to artists 106 who have access to the system 100, some or all of whom provide music content for the music database 120 after registering with the system. The classification database 124 includes classification protocols and other classification data that may be changed periodically or in real time, such as by dynamic modification of classification descriptors by one or more provider personnel 112, 114, 116, 118. The classification database 124 will also be described below in detail.

The server 110 may include connections to provider personnel 112, 114, 116, 118, who collectively may carry out the classification, licensing and other provider services, as well as creation, modification and adaptation of classification protocols (discussed below). Reviewers 114, 116 are preferably assigned to review songs within an assigned genre or catalog of music. In one embodiment, each reviewer 114, 116 is assigned to review one or more songs or musical pieces from a broad genre of music. For example, a reviewer 114 may be assigned to review music falling under the rock genre. The rock genre may be further broken up into sub-genres including, for example, alternative rock, folk rock, ska, emo, indie-pop, blues rock, brit pop, classic rock, early rock & roll, garage rock, gothic rock, grunge, hair bands, hard rock and jam. In this example, the reviewer 114 may be assigned songs that include all or a subset of songs within the rock genre. In one embodiment, the reviewer 114 may only have access to review and classify those specific songs within the particularly assigned genre or sub-genre(s). Preferably, the reviewers 114, 116 are evaluated or tested in a particular category or genre before being assigned to review songs within that category or genre. While only 2 reviewers are shown in FIG. 1A, it should be understood that as many reviewers as would be helpful or necessary to the provider may be used.

The reviewers 114, 116 review the songs within their genre(s) and determine which of the existing classifications apply to each song. Preferably, as previously mentioned, the classifications are compiled into formal, written guidelines and protocols (referred to generally as “classification protocols,” “classification guidelines,” “written guidelines,” “written protocols” or simply “protocols” or “guidelines”) to substantially maximize consistency and uniformity among reviewers (and other provider personnel who rely on the classifications), and allow for such consistency and uniformity to be maintained even under circumstances such as reviewer turnover, newly hired reviewers, or temporary/substitute reviewers (such as to accommodate a busy time period, or vacation and leave of absence schedules).

FIG. 16 illustrates an example of one page of a classification protocol for the rock genre. As shown, the classification protocol may be several pages long (“Page 1 of n”), and include a number of different descriptors, definitions, annotations, attributes and informational links (which may each generally be referred to as a “descriptor” and collectively as the “descriptors”). The links may be provided to, for example, YouTube® clips, provider audio clips, or even informational text such as Wikipedia®. Preferably, the classification protocols are recorded in a common word processor or editor, such as Microsoft Word, so that adaptations and modification to the descriptors, definitions, annotations, attributes and links that make up classification protocols can be easily made, regardless of a user's technical proficiency. Moreover, a document protection password (or the like) may be used to prevent unauthorized users from making changes to the protocols.

The classification protocols may be in hard-copy format and/or may be stored electronically (e.g., in the classification database 124). Preferably the classification protocols are available electronically, and the electronic version may have links that may be accessed to allow ease of use. For example, if a section of the electronic classification protocols relates to “Blues Rock” (under the main genre, Rock), examples of well-known songs may be included with links to audio or video files to allow reviewers to listen to these famous examples (e.g., “Voodoo Child,” by Jimi Hendrix). Continuing with this example, under the “Blues Rock” classification in the protocols, a definition, descriptors, attribute and/or annotation (e.g., trivia about the sub-genre) may be provided to help provider personnel pseudo-objectivize their classifications under this genre (e.g., “Blues Riffing/improvisation” or “guitar heavy”). Moreover, “Blues Rock” may have associated with it in the protocols a link to other derivative or similar sub-genres (e.g., “Classic Rock”) to allow reviewers to immediately jump to that other sub-genre within the written protocols for immediate comparison of the two different types of sub-genres so the distinction is readily apparent, and thus risk of mis-classification in the database is reduced.

The easy access reviewers have to exemplary music within a classification, together with predetermined descriptors, attributes, annotations and a detailed description of the classification itself (e.g., via a Wikipedia link), help to create a pseudo-objective concrete “definition” for the classification, which results in maximizing the reliability and consistency in classifications of music within the database, on a widespread, continual, on-going basis—not simply on a song-by-song or case-by-case basis.

In fact, the reviewers 114, 116 may further review the songs against a variety of classifications in addition to their musical genre and sub-genres. These additional classifications may help facilitate licensing and other provider services. For instance, the inventors have come up with a list of over 700 classifications, including without limitation, classifications for mood (magical, trippy, scary, earthy, lonely, busy, punchy, sexy, carefree), genre (americana, blues, rock, cajun, classical, comedy), secondary genre, instruments (percussion, beat/drums, animal sounds, brass, ethnic instruments, guitar/stringed), vocal themes (i.e., themes as reflected in the lyrics, such as summer, romance, holidays, inner-self, nature, children, etc.), explicit lyrics? (yes, no), vocal type (none, male, female, both, group), language (english, spanish, italian, french).

Finally, the reviewers 114, 116 may further review the songs based on one or more quality categories. These categories may include production quality, vocal quality and/or quality of composition. Guidelines for these quality categories may also be detailed in the classification protocols. In one implementation, each song may be rated by a reviewer on a point system, where 5 points are available for each of the quality categories. The overall quality rating of a song may be the weighted average of the values given to each quality category, or the sum thereof. For example, a song may be given the following values: production quality (3); vocal quality (4); composition quality (2). In a weighted average system, the song may be rated with an overall quality rating of 3, and in a sum system, the song may be rated with an overall quality rating of 9.

In addition, reviewers 114, 116 may provide reviewer description relating to each song. The descriptions are preferably based on predetermined keywords, tag words or descriptors, which are also preferably included in the classification protocols in order to maintain uniformity and consistency among reviewers. Reviewers may also identify songs as unacceptable based on one or more predetermine criteria. Further quality control and uniformity maintenance procedures may be put in place, as described herein.

Generally each song uploaded into the system 100 is initially vetted and approved 170 by one of the reviewers 114, 116 (explained further below). Pursuant to the initial review, the reviewers 114, 116 assign certain keywords, tag words and/or descriptions (collectively referred to as classifications) to each song. In addition, or alternatively, the artists themselves my assign initial classifications to their songs, which may act as a starting point for the reviewers. In one implementation of the invention, the initial classifications, or even subsequent classifications, of any given song, may be modified to more accurately and consistently (within the classification protocols) classify a son music. In such a situation, a reviewer that is initially assigned to review a new song may easily recognize right off the bat that the artist's proposed classification (or other initial classification) is incorrect. The reviewer may propose a different classification and send the song back into the inbound queue to be reviewed by a reviewer in a more applicable classification group.

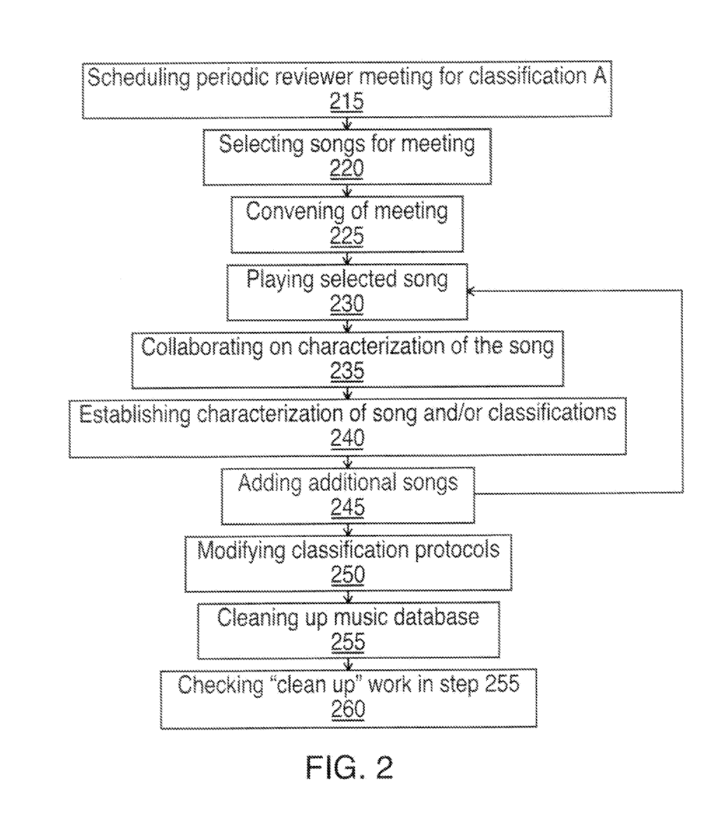

Further, as explained above, the classification definitions themselves may be modified as well. One way this dynamically changing classification system may be accomplished is through a collaborative reviewer meeting and descriptor modification process (referred to as the “Meeting process”). FIG. 2, which will be described below in greater detail, illustrates this meeting process as part of the method of adapting the classification protocols so as to maximize consistency, reliability and uniformity in classifying songs (or other copyrightable works) in both the short term as well as in the long term, in accordance with one embodiment of the invention.

As previously explained, the system 100 preferably comprises a plurality of reviewers 114, 116, with each reviewer responsible for reviewing and classifying songs within one or more assigned genres or sub-genres. There is preferably multiple reviewers within any given genre, so it is desirable that each of the reviewers (as well as future reviewers) within the genre are as substantially consistent as practical and thus collectively review their genre of songs from a pseudo-objective viewpoint based on the criteria set forth in the adaptable classification protocols. An overall process for creating this consistency is depicted in FIG. 1B, but as would be understood by those of ordinary skill in the art having the present specification before them, it may be possible with certain copyrightable material to achieve at least a sufficient amount of this pseudo-objective viewpoint based on the implementation of only a sub-set of the steps disclosed.

FIG. 1B illustrates an ongoing process of gathering and classifying songs, and maintaining concrete classification protocols, so as to maximize consistency, reliability and uniformity in classification, and facilitate identification of selected copyrightable material for licensing to members through a provider network, in accordance with an implementation of one embodiment of the invention. As previously explained with respect to FIG. 1A, the music database 120 and classification database 124 may be combined into a single combined database 150 as illustrated in FIG. 1B, with the database 150 including both music data and information 164, and classification data and information 168. The classification data include the written classification protocols.

Each of the reviewers 114, 116 and the directors 112 is able to receive and listen to songs from the database 150, generally via a link to an audio file stored on the server 110. In connection with the initial review and classification of any given song, a reviewer 114, 116 listens to the song and classifies it using the various classifications set forth in writing in the classification protocols 168. If the song has already been classified, the reviewer 114 or 116 may re-classify or adapt the current classification of the song based on or in accordance with the then-current classification protocols 168. Whether before or after a song has been initially classified, discussions and collaborations may take place during committee meetings (180a-n), or during individual or group discussions (such as via teleconference or instant message session using the instant messenger module 128).

Certain outcomes 185 from the committee meeting reviews 180a-n may result (e.g., decision to change the classification protocols 168, decision to change the classification of a song, or the decision to add an entirely new classification to the protocols to accommodate a new type of music that does not properly fall under any existing classification). Changes to the classification of a piece of music, or to the classification protocols themselves, may arise out of discussions or input from other reviewers, supervisors 112, directors 118 or other provider personnel, such as through the instant messaging module 128, in-person meetings or telephone discussions (not shown). As part of the process illustrated in FIG. 1B, supervisors 112 may also listen to music from the database 150 and make corrections to song data/classifications.

Each committee meeting, as discussed below, preferably focuses on a single or small number of classifications, as depicted in FIG. 18 by the various committee reviews 180a, 180b, 180n, corresponding to a classification “A” meeting, classification “B” meeting, and classification “N” meeting (where “A”, “B”, and “N” may each represent a single classification or group of classifications). In connection with each of the meetings, reviewers, supervisors and/or directors listen to music 164 from the database 150 and together view and discuss certain classifications of that music (such as set forth in the classification protocols), also from the database, and provide corrections or amendments (as agreed upon) to the classifications in the music data itself 164, or the classification protocols and/or other classification data 168. In addition to making corrections in the actual database 150, the committee meeting may have certain outcomes 185, which may include information being provided to the reviewers as well as subsequent tasks or corrections (including “clean up” tasks or changes) to the database 150.

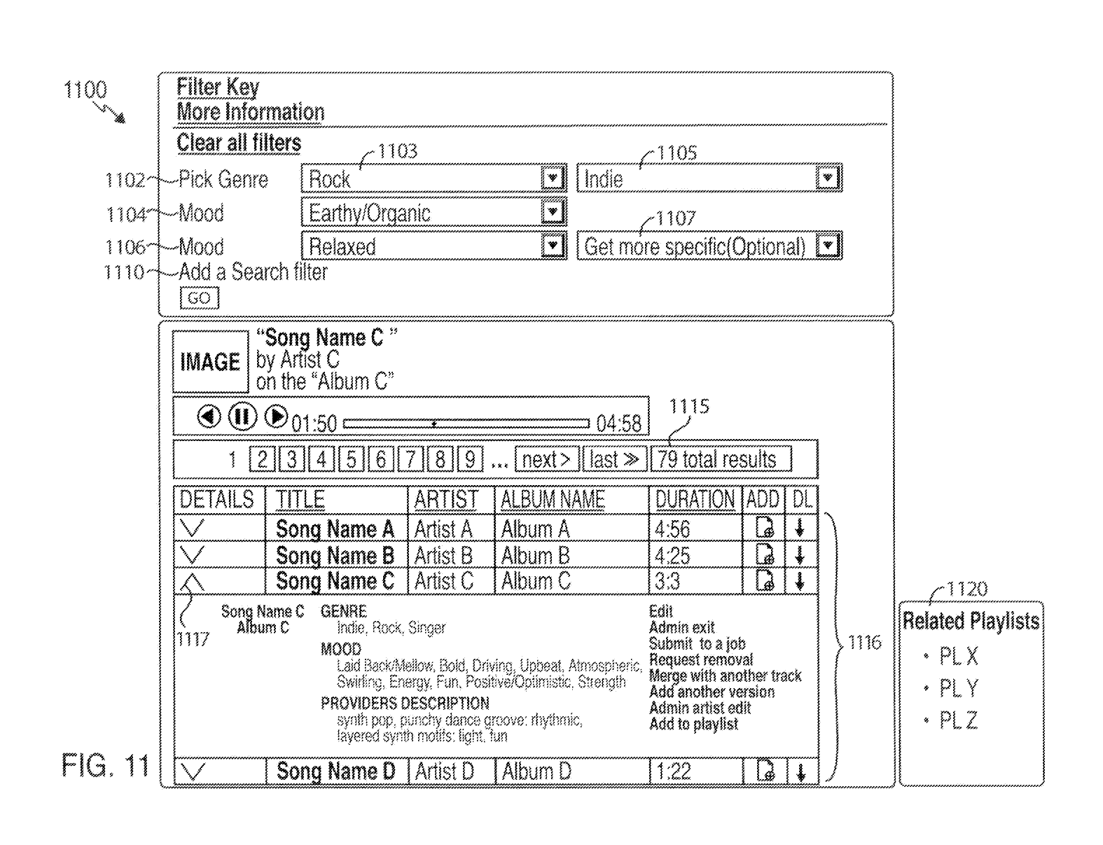

As shown in FIG. 1B, the process includes queries being made by search module 126 to the database 150, with responses being provided to the search module 126 (as discussed with respect to FIG. 11 below). Playlists 190 may be created by individuals, including supervisors 112, directors 118, reviewers 114, 116, and other third parties 135, based on any number of songs from the database 150, including songs identified based on one or more search inquiries through the search module 126. Licensing deals 195 may also be achieved in the illustrated process based on, for example, an individual's or entity's review of the songs from a playlist. The playlists 190 may be stored in the music database 124, the combined database 150, a separate playlist database (not shown), a system interface, or some other known means in the provider network or “in the cloud”.

Moreover, when reviewers 114, 116 review music for the purpose of classifying or re-classifying the music, they may run various filtered searches using the search module 126 to obtain information useful in making such classifications or re-classifications. For example, if there is a particular song that sounds like another song in the database 150, the reviewer 114, 116 may search for that song, or other similar songs, to investigate how such song(s) have been classified, allowing a comparison with already classified songs to assist in creating pseudo-objectivity, and thus maintain consistency for the aggregate song classifications in the database 150. As will be understood by those of ordinary skill in the art, these filtered searches provide a mechanism for sorting through tags, attributes and other metadata assigned to each song in the database 150.

As depicted by FIG. 2, personnel in each classification (or genre) meet periodically to advance (and further understand) the classification definitions, descriptors, attributes and annotations, for each classification or genre which they are qualified to review. The main genres may include, for example, rock, jazz, electronic, and examples of one or more sub-genres may include, for example, classic rock, alternative rock and/or folk rock (under the “rock” main genre). It is also contemplated that periodic meetings may be convened for a mood classification (e.g. relaxed, romantic, sad) or a commonly appearing motif classification (e.g. love, sunny days, breaking up) in addition to (or even instead of) meetings with respect to certain genres or other potential classification schemes

This strand of the process for adapting the classification protocols so as to maximize consistency, reliability and uniformity begins with scheduling a meeting of all or a subset of reviewers (step 215). Preferably, the subset of reviewers scheduled to attend the meeting are reviewers assigned to a common classification, genre or even a sub-genre. For example, a meeting of all the reviewers in the rock genre may be scheduled to attend the meeting in step 215. Or the meeting may be for all reviewers that review a handful of predetermined rock sub-genres (e.g., if there are 30 sub-genres within the main rock genre, the meeting may include only those reviewers assigned to a select 15 of the 30 sub-genres). For less common genres of music, a meeting may be scheduled to include personnel associated with more than one genre. In such a situation, it may be found that because two or three main genres have similar sounds (e.g. polka and waltzes; swing and be-bop), reviewers within those similar genres would benefit from a cross-genre collaborative meeting to further define the classification protocols and songs within those similar genres. The meetings may be scheduled, for example, weekly, bi-weekly, monthly basis. However, it should be understood that these meetings may also be held on-the-fly (i.e., last minute) or on an ad hoc basis.

One or more songs are selected for consideration at the meeting (step 220). In one embodiment, supervisor 112 selects one or more songs (preferably between two and five songs) that are (or proposed to be) classified within genre A or other classification associated with the meeting. The selected songs may be in the music database 120 or may be commonly known songs that the supervisor 112 seeks to use to help better define a genre. For instance, most rock lovers are familiar with the sounds of certain performers like the Beach Boys, Simon & Garfunkel, The Grateful Dead and Eagles. Consequently, these reviewers can utilize these prior musical experiences to help categorize future music in the database. Of course, copyrighted material, especially music, is constantly evolving so nothing may help to classify the new music coming into the database 150 like music from the database 150, itself. It is further contemplated that the supervisor 112 may receive suggestions between the periodic meetings for one or more songs that should be reviewed at the next periodic meeting from one or more reviewers 114 and 116 and even from director 118. Some of these suggestions may be sufficiently important so as to warrant an ad hoc meeting. As would be understood by those of ordinary skill in the art having the present specifications before them, any such ad hoc meetings would be conducted in substantially the same manner as discussed in the next paragraph with respect to periodic meetings.

The meeting is then convened, via face-to-face, web conference, video conference, teleconference and/or other remote communication means (step 225). Where such conferencing is used the conferencing application may be provided by the conference module 136 on the provider's server 110, or some other known web-based or conferencing application, such as Webex by Cisco Systems. In a context where the copyrighted subject matter is music, this conferencing module 136 must have audio transmission capability between a plurality of participants, at least so the participants can hear the music being covered at the meeting. Conferencing module 136 also preferably allows audio transmission of the discussion between the various participants and may also facilitate text transmission between the same (or some subset of the) plurality of participants. Furthermore, conference module 136 may allow the various participants (or some subset thereof) to see the search module 126 in real time. Additionally, conferencing module 136 may save an audio record (preferably with synchronized screen shots) of the meeting for later review with the record being stored in an accessible way in the classification database 124.

During each meeting, selected song(s) (or portions thereof) are played for the attendees of the meeting (step 230). Preferably, the songs are played such that they may be listened to substantially simultaneously by all participants. In connection with playing a given song during the meeting, the meeting participants collaborate on the appropriate characterization of the given song (step 235). Discussion topics for this collaboration may include, but are not limited to: (1) whether the given song was misclassified; (2) possible new classifications within the relevant genres or sub-genres in which the song may be classified or reclassified (as applicable); (3) new or revised classification definitions or descriptors for the classifications relevant to the song; and (4) key musical attributes of the song.

The presentation and collaborative discussion relating to each song may result in an established characterization relating to the given song (step 240). For example, if a discussion is had about whether the song was misclassified or misdescribed and why, attendees may propose proper (or new) classifications for the song and/or proper (or new) descriptors for the particular classification(s). Similarly, perhaps it is agreed that the song was classified into the proper genre, but that none of the prior sub-genres fit the song, and so one or more new sub-genres may be proposed and established by the group, along with a proposed definition or descriptor for the new proposed sub-genres. And if certain musical attributes identified by the attendees are new and not yet included in the written classification protocols, such musical attributes (again, with proposed descriptors) may be suggested and perhaps established during the meeting. As part of this process one or more participants may raise issues with additional songs that may be affected by the changes established for the classification protocol (step 245). One or more of these additional songs may be pulled up from the music and classification databases 120 and 124 for review during the meeting as part of steps 230-240.

After the presentation proposals and suggestions are established (step 240), the written classification protocols may be modified, both with text and/or new links to example songs or similar genres, as discussed above (250). Finally, if it is determined at the meeting that drastic changes are required to be made to the written protocols, one or more reviewers may be assigned certain “clean up” tasks toward reworking previous music reviews to make sure they are in line with any newly decided protocols (step 255). Once any such reworking of the databases is accomplished it may be desirable to have a second reviewer or supervisor review at least a subset of the corrections by the first reviewer to further eliminate any subjectivity (260). As would be understood by a person of skill having the present specification, the database may be designed to indicate a change history for reviews for tracking and validation processes.

As shown in FIGS. 1A and 1B, system 100 also preferably includes instant messaging module 128. Instant messaging module 128 allows one or more of the provider personnel (e.g. supervisor 112, reviewers 114 and 116 and director 118) to jointly review a piece of music and jointly discuss classification issues in real time. In this manner the instant messaging module acts to facilitate ad hoc collaborative reviewer meeting and descriptor modification processes in substantially real time. If such instant meetings result in the establishment of new classifications, keywords, genres, sub-genres, etc. all provider personnel may receive a message (e.g. via email or instant messaging) regarding the change.

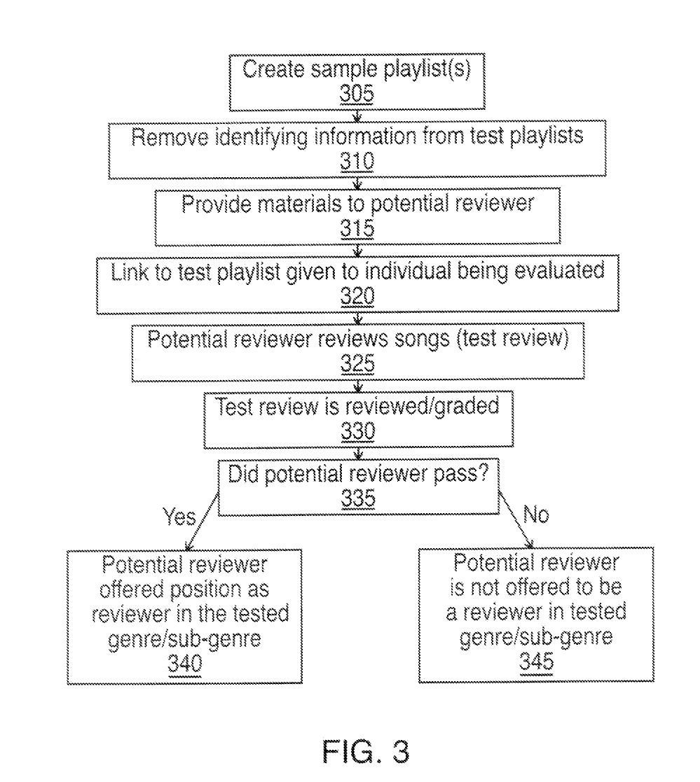

Another way to maximize consistency among reviewers and eliminate subjectivity, any individual wishing or requested to review music within a particular genre or sub-genre (either a new reviewer, or an existing reviewer in another genre/sub-genre) may be evaluated and/or tested before being authorized to review songs within such genre or sub-genre. FIG. 3 illustrates an example implementation of a reviewer testing/evaluation procedure in accordance with the invention.

First, one or more test playlists are created (step 305). Each test playlist may consist of 5-10 genre and/or sub-genre specific songs. The test playlists are preferably created using the search module 126. However, as explained above, the playlists created by the search module 126 include the genres, sub-genres, moods, descriptors, descriptions and all other classification information. Because the individual is being tested/evaluated on this information, such information should be removed from the test playlists (310). This may be accomplished by either creating a clean playlist having only a lists of the names of the songs, and only links to the respective audio files. This may be done via the testing module 130, wherein such test playlists are stored separate and apart from the search module 126 or music database 120.

Next, material may be provided to the individual being evaluated (referred to as the “potential reviewer”) to investigate and study before being tested/evaluated (step 315). These materials may include all or a subset of the classification protocols, or they may include other materials adapted or created specifically as a study guide for potential reviewers. In addition, the materials may include links to audio files to allow the potential reviewer to listen to musical selections (or a portion of those selections) associated with the applicable classifications. For instance, the database 124 may include examples of sub-genres, lyrical, vocal and instrumental styles associated with the particular genre, and other information that defines attempts to objectify various potential variables found within a particular genre and/or sub-genre of music.

While this step of providing materials to allows the reviewer to study up on the classification process generally conies after the playlists are created and modified as set forth above (305, 310), it should be understood that the review materials may be provided to the potential reviewer (step 315) at any time before the evaluation test. In one implementation, the review materials may be stored on the server 110 and accessed by a potential reviewer via the network 102 at any time. Such access may be granted via a login/password or some other known secure means.

A link to the test playlist(s) is then provided to the potential reviewer in the given genre or sub-genre (step 320). The potential reviewer then reviews the songs on the test playlist in the same or similar manner as a regular reviewer in that genre or sub-genre (325). In one embodiment, the potential reviewer may review the songs (325) online. However, in order to avoid interfering with the same songs within the actual music database 120, a “dummy” or practice file of the song is set up in a test music database in the testing module 130 so that the potential reviewer appears to be modifying the classifications of the song without modifying the actual song in the production database. Alternatively, on offline version (e.g., in Microsoft Word® format or some other known processor or editable text application) of the review page(s) may be provided to the potential reviewer to fill in.

In connection with step 325, wherein the potential reviewer reviews the songs on the test playlist, the potential reviewer may be required to identify the mood, genre/sub-genre, BPM, whether there are explicit lyrics, similar famous artists, featured instruments, vocal type, and time signature. In addition or alternatively, the potential reviewer may be asked to write a short description of each song, as well as to rate the quality of the songs pursuant to one or more quality categories (as discussed above).

After the potential reviewer completes the “test” review, a provider personnel (e.g., an existing reviewer, supervisor, director) may review or grade the completed test (step 330) and determine if the potential reviewer “passes” the test (335). The test reviewer may check to see how close the potential reviewer came to the actual classifications of the songs on the test playlist within the music database 120, as generally the more consist the test results are to the actual classifications, the less subjective and more uniform the system becomes. The provider may establish guidelines for scoring and how accurate a potential reviewer must be in order to pass the test review.

If the potential reviewer passes the test, he/she may be asked to be a reviewer in the tested genre/sub-genre (340). If the potential reviewer fails the test, he/she may not be asked to be a reviewer in the tested genre/sub-genre (345). Alternatively, if the potential reviewer fails, he/she may return to step 315 where provider may provide additional materials to the potential reviewer, who continues to study and review classification definitions for the applicable classification toward better preparing for the examination. As would be understood by those of ordinary skill in the art having the present specification before them, the number of times a potential reviewer may be allowed to take the examination may be limited. Moreover, it is contemplated that supervisor 112 or director 118 may assist the potential reviewer in passing the examination by explaining the errors made in their prior examination. In yet another implementation, the reviewers 114, 116 may be required to periodically take tests in accordance with FIG. 3 to ensure he/she is keeping up with his/her review skills (in which case the term “potential reviewer” would include the reviewers 114, 116).

A supervisor 112 may be connected to the network and one or more of the reviewers 114, 116 as an additional measure to maximize consistency/objectiveness in classification of music and the particular reviewers' 114, 116 work. In one embodiment, the supervisor 112 may randomly pick reviewed songs from the classification database 124 to review the quality categories and keywords/tag words selected by the one of the reviewers 114 and 116 for re-review. The supervisor 112 listens to the music and may determine that the information previously input was incorrect and modify the information in the database. In one embodiment, a communication is sent to the one of the reviewers 114, 116 that had originally reviewed the now corrected database entry with an indication of the information that was corrected by the supervisor 112. This communication, which may be through email or instant message (via the instant messaging module 128), may have a link to the audio so the reviewer can reconsider the classification of the music.

In some embodiments, the system will randomly place reviewed songs into a queue for supervisor review. In these embodiments, the system may place songs reviewed by newer reviewers more heavily into the supervisory queue. Similarly, if the supervisor is revising the entries of a particular reviewer more often than others, the system may include further entries input by that reviewer. In some embodiments, when a veteran reviewer begins reviewing music from a new genre not previously reviewed by that reviewer, the system may treat reviewed songs by that veteran reviewer in the new genres as reviews by a new reviewer.

A catalog director 118 (also referred to simply as a “director”) may also be connected to the server 110 within the provider network 108. The director may have the responsibility of directing or managing the databases 120, 122, 124, as well as creating playlists for members 104 using the search module 126. The tasks described as being carried out by the catalog director 118 may also be carried out by the supervisor or one of the reviewers in alternative embodiments. In one implementation of the embodiment of FIG. 1A, the catalog director 118 may be responsible for selecting songs and creating playlists using the search module 126.

The search module 126 will now be described in detail. The search module 126 interacts with the music database 120 to identify songs meeting one or more of a number of searchable attributes. These attributes may include, without limitation, the following filter options: vocal, instrumental, main genre, secondary genre, mood, vocal type, explicit lyrics, instrument, keyword, description, lyrics search, vocal theme, language, beats per minutes (“BPM”), duration, time signature, key, era, artist, song title, album title, and sounds like. These filter options will be understood to one of ordinary skill in the art, however Applicants provide further explanation for the following:

Secondary Genres: Sometimes a song that is primarily of the a particular genre classification (e.g., “Rock”) will contain other, “lesser” main genre characteristics. The “secondary genre” search function allows the user to filter songs in the music database 120 by several secondary genre attributes. The secondary genre filters may include the following classifications: like urban rock, classical rock, “funky-ness rock,” or “urban-ness rock.”

Keyword, Description and Lyrics: These search filters may allow users to search through specific words or content included within the entire song review. A lyrics search may, for example, search a section of the review entitled “Vocal Themes” where lyrical attributes and subject matter are accounted for, which may be useful when specific lyrical content is desired. For example, if someone is looking for a song about summer, the “Vocal Themes” may be searched to find songs with lyrics consistent with the theme of summer. In some embodiments, this information may be populated automatically through the use of a speech to text engine.

Vocal or Instrumental: This filter may also include subsets for “a capella” and “minimal vocals.” If vocals are the primary focal point of the song, the track may be designated as “vocal.” Similarly, if vocals are of a secondary function to the overall track (e.g., intermittent vocal noises, vocals used percussively, vocals buried within the track, synthetic (non-human) vocals, or vocals used only as backgrounds), the song may be tagged with “minimal vocals” and may be identified as such during a “vocal or instrumental” search.

Any of the filter options described above may have a plurality of options, each of which may have their own sub-sections or sub-options. For example, the “main genre” filter may include rock, urban, funk, folk, jazz, and disco, just to name a few. And the “rock” option under the main genre filter option may include any number of sub-genres, including without limitation: alternative rock, folk rock, ska, emo, indie-pop, blues rock, brit pop, classic rock, early rock & roll, garage rock, gothic rock, grunge, hair bands, hard rock and jam.

Once a search is run in the search module 126 using the filter options, the results may be sorted in any number of ways. For example, the results may be sorted alphabetically by song name, alphabetically by artist name, by date of publication, or by rating. The rating may be based on a rating value given to each song by the reviewers, and the playlist may be automatically sorted so that the highest rated songs in the playlist are shown first.

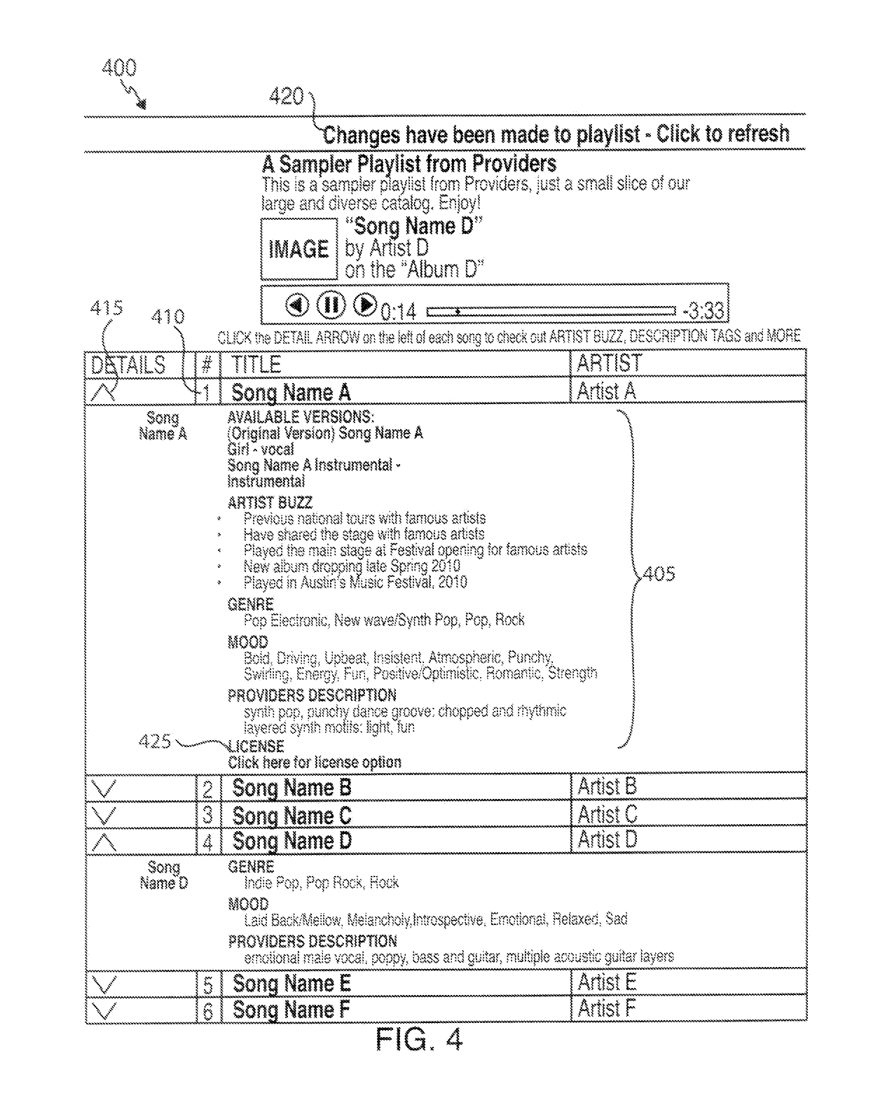

FIG. 4 illustrates an example of a playlist 400 populated with a select number of songs. In one implementation, song details 405 are included. Preferably the playlist 400 is interactive. As such, each song 410 has an icon (such as an “up” or “down” arrow) allowing a user to show more or less of the information. The details 405 may indicate various features of the song 410 including available version, information about the artist (e.g. “artist buzz”), genre, mood and a description of the song, preferably using predetermined keywords or tag words so as to maintain consistency among descriptions of songs.

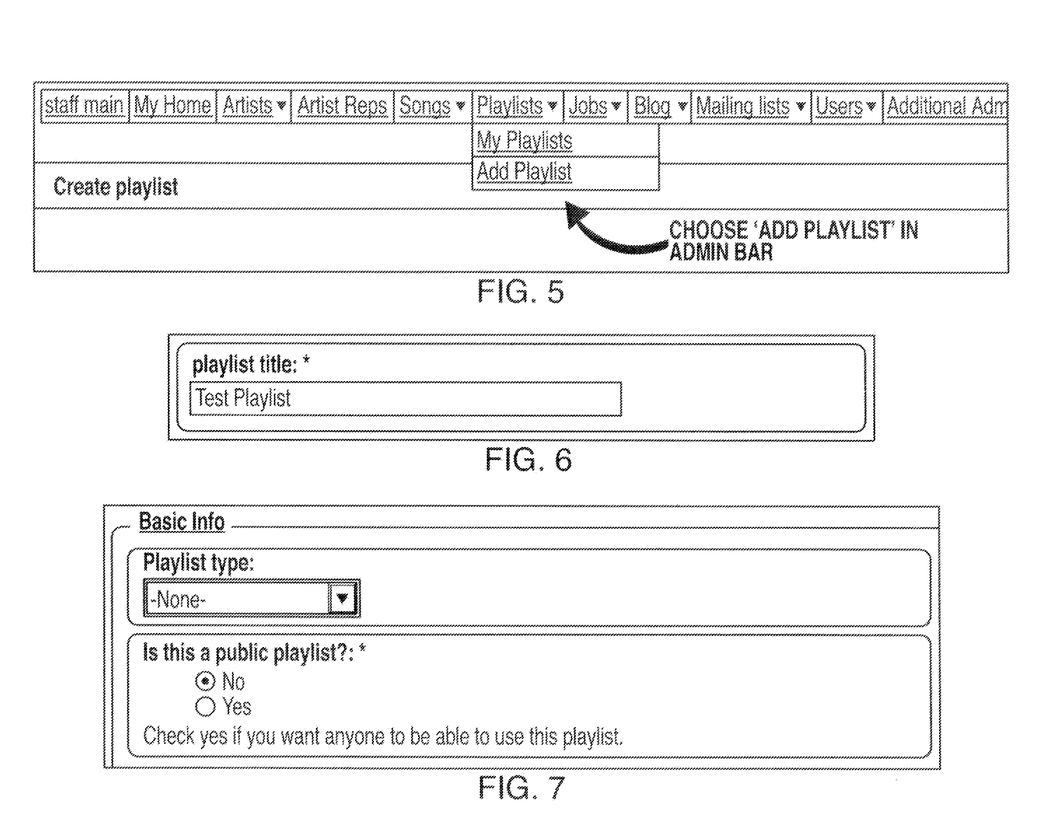

FIGS. 5-10 illustrates the various steps that may be carried out to initially establish a playlist in the provider network prior to the playlist being populated with songs. Playlists may be established by the members 104, artists 106 or provider personnel 112, 114, 116, 118. For purposes of explanation, the following description will explain how a playlist is established by a catalog director 118. However, one of ordinary skill in the art would understand that any of the other possible users may create playlists in a very similar manner.

FIG. 5 illustrates an example navigation bar 300 shown via a GUI of the director's system interface 119. The director 118 may first choose “ADD PLAYLIST” from a dropdown menu as shown. FIG. 6 illustrates a pop-up or other interface screen requesting that a playlist title be entered. Once the title of the playlist is entered, general information relating to the playlist being established may be entered (FIG. 7). A dropdown menu may be provided for the director 118 to enter the playlist type. For example, the playlist type may be “Internal List Only” or “External Client List”. The director 118 may also designate whether the playlist is a public playlist or not.

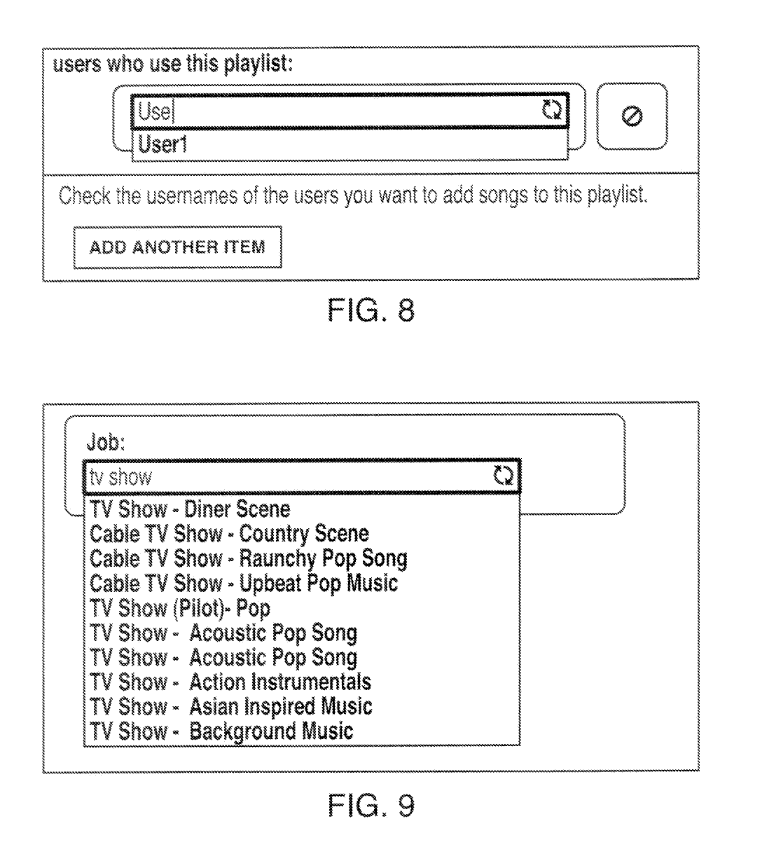

In one implementation, the director 118 may provide specific editing or use rights associated with the playlist, as shown in FIG. 8. For example, the director 118 may add certain reviewers to a list of individuals that may edit the playlist, or he/she may member users to the list of approved editors of the playlist. The “user” list provided by the screen shown in FIG. 8 may be a fill-in-the-blank type of list, a dropdown menu, or radio buttons. In a preferred implementation, the user names may automatically populate as they are added, and as many users may be added as desired.

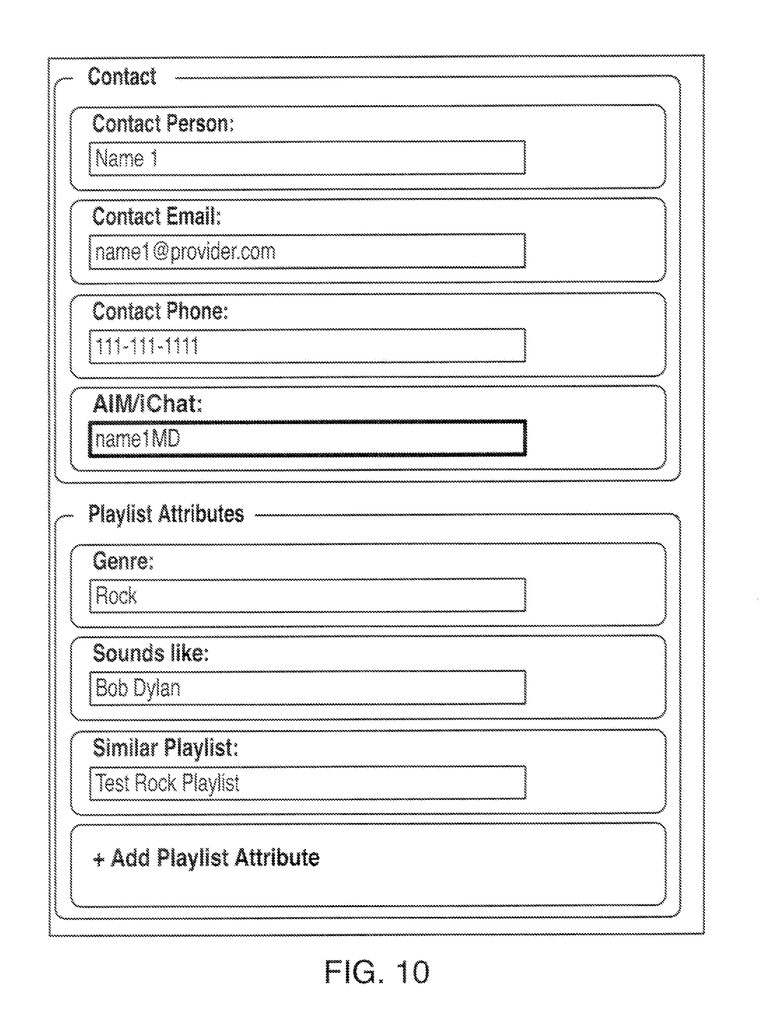

FIG. 9 illustrates a screen shot showing a drop down menu of playlist jobs that may be selected. This dropdown menu may be, for example, a list of all existing projects, or a list of possible job types with which to associate the playlist. FIG. 10 illustrates a playlist information page. The playlist information page may include contact information for the individual or entity for whom the playlist is being created and/or who is creating the playlist. Typically the contact page will include name, email address, phone number and AIM/iChat id. The playlist information page may also include playlist attributes that may selected by the creator of the playlist. For example, the playlist may be tagged as a “Rock” playlist, or may be identified as “Soundslike” Bob Dylan. It may also be useful to identify the playlist as being similar to other existing playlists. Other possible data that may be input at the contact page shown in FIG. 10 may be edit or display permissions, other playlist description fields, and background images (e.g., photo of the customer/client or of a logo associated with that customer/client).

The data associated with the playlist as described in connection with FIGS. 5-10 will be stored in the music database 124. As such, when a search is run using the search module 126, filters relating to similar playlists may also be included. While FIGS. 5-10 are described with respect to initially establishing a playlist in the provider network, it should be understood that the information regarding an already established playlist may be edited in the same manner. For example, if it is unknown ultimately what the “soundslike” tag should be until the playlist is populated, that tag may not be included when establishing the playlist, but may be added later on.

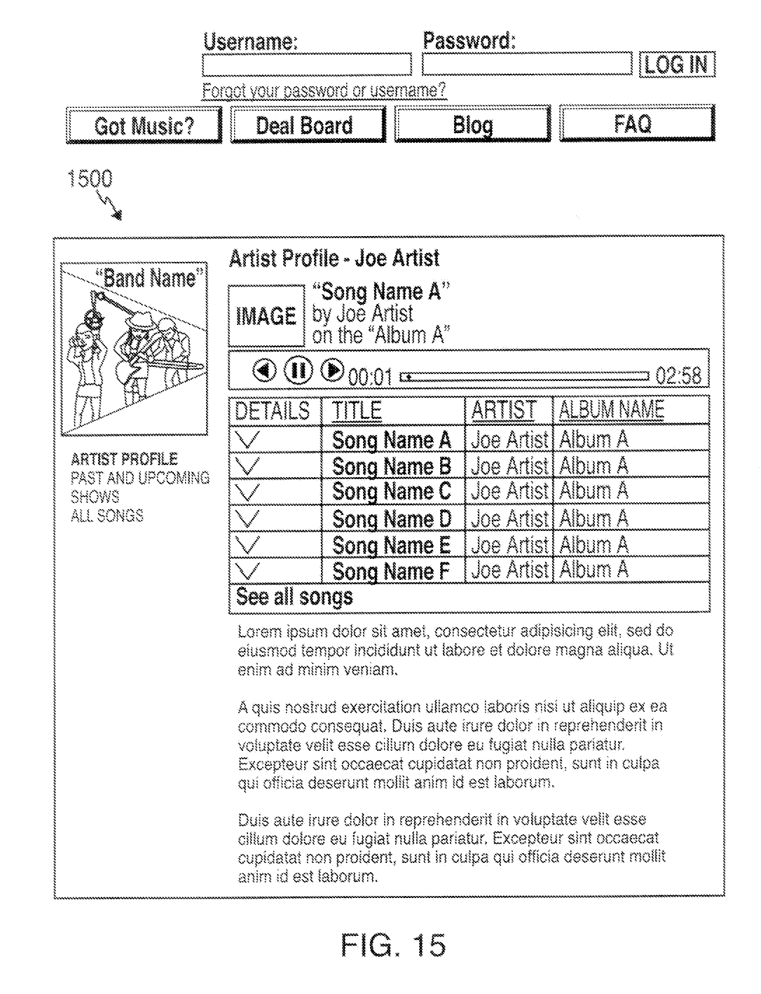

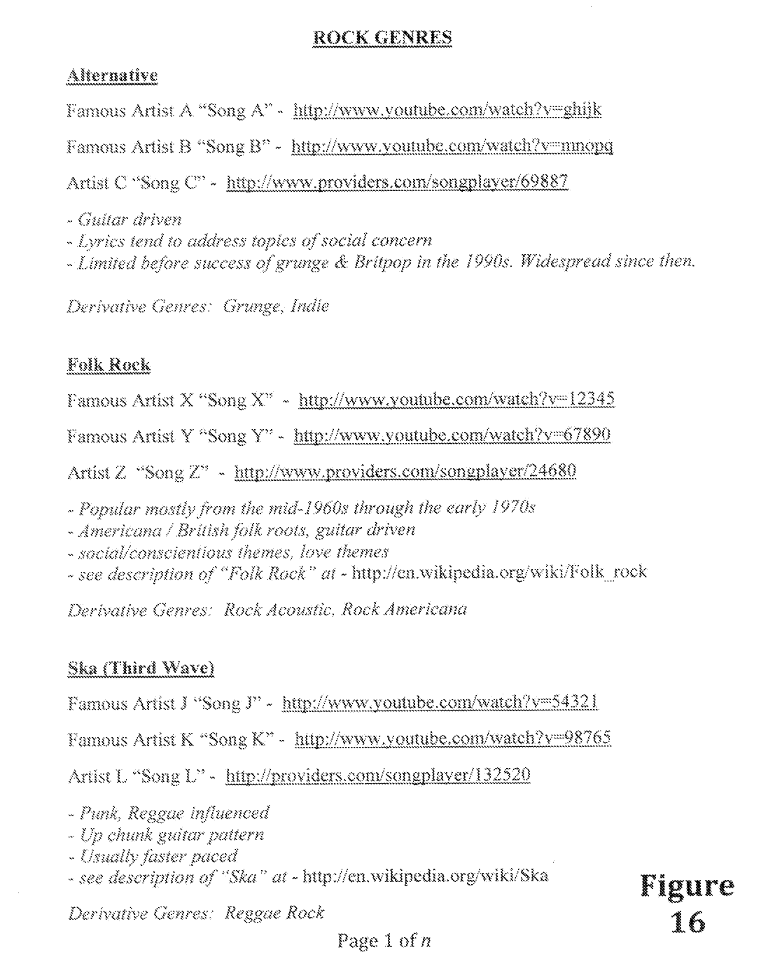

Once the playlist is established as described in FIGS. 5-10, the playlist may be populated with songs. The songs used to populate the playlist may be added at any time and from anywhere in the system 100. For example, songs may be manually selected by the playlist creator based on requests from the member 104 for whom the playlist is being created. Similarly, songs may be added to a playlist directly from an artist's profile page (discussed below with respect to FIG. 15), or from a collection of songs submitted pursuant to a submission request (also discussed below).

One useful way to populate a playlist is by adding songs from the results list of a search using the search module 124. FIG. 11 illustrates a search screen that may include any or all of the filter or classification options described herein, with a list of search results (79 results in the example shown) based on the selected filter options. In the example shown in FIG. 11, a search is run using the main genre filter 1102 (Rock 1103), a sub-genre (Indie 1105), and two different mood filters 1104, 1106. As shown, a “mood” filter may have a “sub-mood” filter option 1107 that allows the director to filter by a more specific mood. For example, a “relaxed” mood may be further defined as earthy, laid back, mellow, lazy, peaceful or calm.

When running a search as shown in FIG. 11, additional filter options may be added by selecting “Add a Search Filter” as shown at 1110. When the search criteria are entered, the director 118 may select “Go” to run the search. As will be understood by those of ordinary skill in the art, these filtered searches provide a mechanism for sorting through attributes and other metadata assigned to each song in the database 150. The corresponding search results 1116 are then shown on the screen and can be reviewed by the searcher. As will also be understood by those of ordinary skill in the art, the results 1116 of the filtered searches are an aggregate of songs in the database 150 which have been assigned or tagged with the particular attributes and metadata defined by the search parameters identified in the selected filter options.

In addition to songs being identified by the search, the search may identified any number of related playlists 1120 based on attributes that have been used to tag the playlists. Preferably, the search results 1116 will be sorted from highest quality rating to lowest quality rating. Alternatively, the searcher may elect to sort the songs in some other manner. In the example of FIG. 11, the search resulted in 79 hits (sec 1115). Each song in the search results 1116 may be expanded 1117 to provide additional information relating to the song. In addition, an options menu 1119 may be provided for each song in the search results 1116. The options menu 1119 may include one or more of the following options or functions:

| | |
|---|---|
| EDIT | Navigates to the artist page edit section where the |
| | artist's specifics can be changed by the artists |
| | themselves. These fields include without limitation, |
| | song details, writer and copyright information, song |
| | exceptions, custom splits, and general meta data |
| | tags. |
| ADMIN EDIT | Similar to the general ‘edit’ page except this is for |
| | administrators only. This allows administrators |
| | (typically provider personnel) to see all of the |
| | specific attributes or classifications of each song. |
| SUBMIT TO A JOB | Every time a new job opportunity or project is |
| | created (e.g., on behalf of a member 104), a sales |
| | person or administrator (provider personnel) enters |
| | the job/project specifics on the website. In addition |
| | to adding songs to playlists, songs can be submitted |
| | to specific jobs. |
| REQUEST REMOVAL | Allows removal of the song/track from the music |
| | database 120 - this function puts the song in a sort |
| | of ‘limbo’ where it then can be deleted by a “master” |
| | administrator (e.g., a supervisor 112 or director 118). |
| MERGE WITH ANOTHER TRACK | All versions of the song (e.g., vocal, instrumental, |
| | etc . . .) are uploaded individually. This feature allows |
| | songs to be merged so that all versions of a song can |
| | be viewed in one place. |
| ADD ANOTHER VERSION | Navigates you to a song upload page where a new |
| | song (e.g., a version of the current song that is not |
| | already in the system) can be merged with the |
| | current song. |
| ADMIN ARTIST EDIT | This feature enables editing of the artist information |
| | such as ‘buzz points,’ primary contact, payee info, |
| | exceptions, etc . . . |
| ADD TO PLAYLIST | This function forwards a song to a playlist for |
| | submission to a client. |

Based on the searcher's review of the search results 1116, the searcher may add songs from the search results 1116 to one or more playlists by forwarding selected songs from the search results 1116 to selected playlists. For example, if the searcher wishes to add Song Name C to “Sampler Playlist from Providers” (as shown in FIG. 4), he or she would select “Add to playlist” in the menu options. The searcher would then select “Sampler Playlist from Providers” from a list of existing playlists, thus forwarding Song Name C to that playlist.

In one embodiment, it would be useful for a searcher to be able to save pending searches in, for example, a personal workspace of the searcher. This is particularly advantageous where a search uses a large number of search filters that would be difficult to remember without memorializing it in writing. Rather than the searcher having to write down all the search filters used for a pending search, he or she may simply save the search, with all of the previously selected filters, to come back to later. In the searcher's same personal workspace, he or she may also upload and save video or image files related to any searches or playlists he or she is working on. For example, if an advertising agency has prepared a demo or preliminary proof for an advertising campaign, it would be useful to the individual creating the playlist for that particular ad campaign to be able to access these materials as the playlist is being populated.

Each playlist preferably has a unique URL associated with the playlist. The URL link may be a public link or may be password protected. In one implementation, the director may be able to modify the playlist while the member 104 is viewing it. At any time, that URL may be provided to an intended recipient of the playlist at any time so that the recipient may listen to the songs in the playlist. Preferably, the playlist may be edited even after it is provided to the recipient (e.g., a member, client or customer). This may be desirable for a number of reasons. For example, if a song on the playlist is found to be subject to third party copyright rights after the playlist is provided to a recipient, and thus removed from the music database 124, it would be desirable to be able to update the playlist in real time. In another situation, a director 118 (or other provider personnel) may wish to send the recipient (e.g., member 104) a preliminary playlist before finalization of the playlist. Or in some circumstances, the recipient's requirements may change after the playlist is provided to the recipient, so the playlist would need to be modified.

In any of these (or other) cases, the recipient may be viewing a local copy of the actual playlist stored in the database 150 at the same time that the playlist is being edited. The playlist link provided to the member 104 may be configured so that a message indicating changes have been made shows up in real time on the member's graphical user interface 105, as shown at 420 in FIG. 4. In other words, while the member 104 is reviewing the playlist that has been provided by the director 118, a message may pop up on the member's screen that states “Changes have been made to this playlist. Click here to refresh,” or the like. Upon clicking this message (or a corresponding “refresh” link), the playlist would be immediately refreshed to reflect the changes that were made by the director 118.

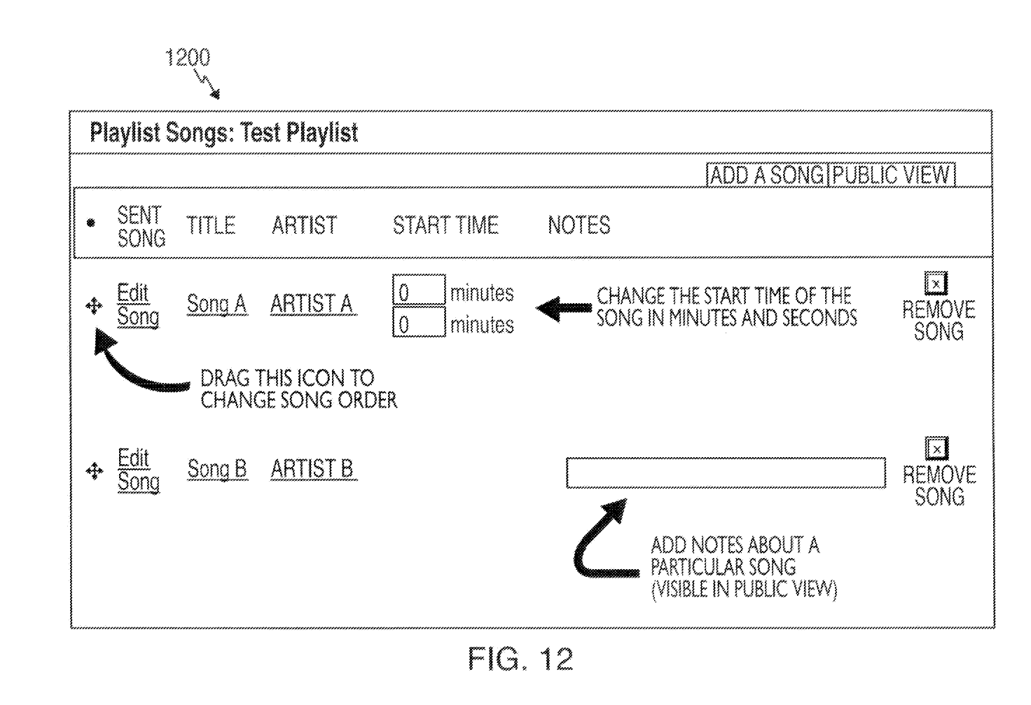

FIG. 12 illustrates a playlist editing screen 1200. In this screen, users may change the order of songs, add relevant notes about a particular song, choose a start time (such as, for example, if the relevant part of a song is in somewhere in the middle of the song), or remove a song from the playlist.

In one implementation of the invention as described above, the director (or some other personnel or agent of provider) creates the playlist for members 104 upon request of the member. In some situations, the members 104 are the actual intended users of the playlist or songs within the playlist. For example, leading brands or independent film producers may be looking for particular genres or types of music for their own commercials or films, respectively. Alternatively, the member 104 may be a liaison to the ultimate user of the playlist or songs (referred to as the “customer” 130 in FIG. 1). For example, an advertising agency member 104 charged with the task of creating an advertising campaign for a customer 130 may request that the provider create a playlist according to the ad agency's specification, which the ad agency may then provide to its customer 130 under the ad agency's own branding.

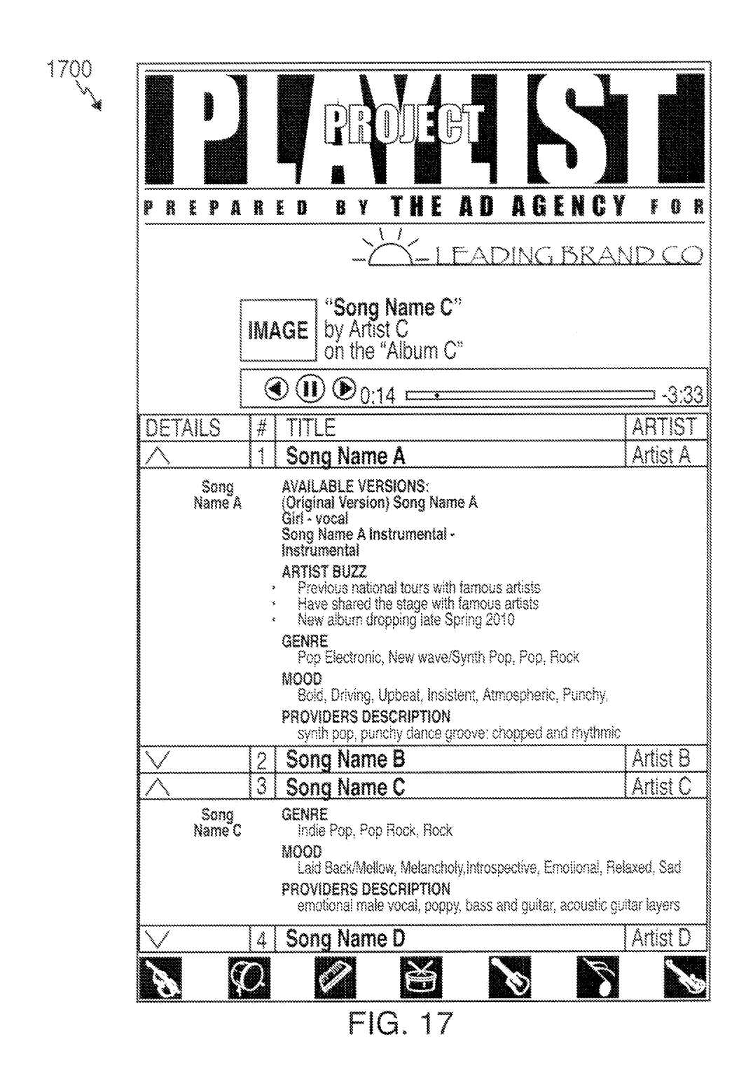

FIG. 17 illustrates an example implementation of the customization of the design of a playlist. In particular, FIG. 17 shows that the visual design of a playlist may be customized by, for example, branding the playlist with a member ad-agency's logo and provided by that member ad-agency to one of its own customers (e.g., a leading brand) as if it was prepared by the member ad-agency in connection with a proposed advertising campaign, even if it was actually prepared by the provider. This is analogous to the OEM business model in the product manufacturing world. In another implementation, the visual appearance of the playlist may be designed in accordance with a particular theme (e.g., a″ summer theme for a “Summer Sampler” playlist, or a Christmas theme for a “Holiday Sampler” playlist). A user can change the visual appearance of the playlist using known user interface tools.

It is preferable that the playlist be provided to the member 104 via a network link. For example, the playlist being created in the example shown in FIG. 6 (“Joshua Test Playlist”), may be located at the following unique sample URL: http://www.provider-name.com/playlists/joshua-test-playlist. In the case where an ad agency member 104 wishes to identify itself as the source of the playlist when sending it to its customer 130, the provider may design the page at the playlist link in such a way as to conceal itself as the source, such as by utilizing the ad agency's logo, look and feel, etc. In addition or alternatively, the link given to the customer 130 may actually be a link to the ad agency member's 104 own website, wherein the playlist content may be framed within the member 104 window.

As explained above with respect to FIG. 1, the provider network includes a music database 120 located on the server 110 to which songs may be added or removed by artists or artist representatives, or from which individual songs can be selected and playlists can be created as explained above. Each artist may also create an artist profile in the artist database 122. Before creating a profile, an artist may first create an provider account (with a login, password and associated email address), or an account may be provided for the artist by the provider. Preferably, the artist may submit requested or desired information via a network interface 107. Alternatively, the information may be sent to the service provider who would then input the information to create the profile on behalf of the artist.

In accordance with one embodiment of the invention, the provider server 110 may be configured to receive submission requests and make those submission requests available to all, or a subset of artists 106 in the system 100. A submission request, similar to a “request for proposal” in other industries, is a request for artists to submit music meeting certain attributes, descriptors or criteria. A submission request in the context of this invention may be submitted by members 104 themselves, or by provider personnel (e.g., reviewers, supervisors, directors, or sales or other representatives). The use of submission requests may be desirable in situations where, for example, a search has very few or zero results, or it is determined that very few or none of the songs in the search results 1116 are appropriate for the particular search.

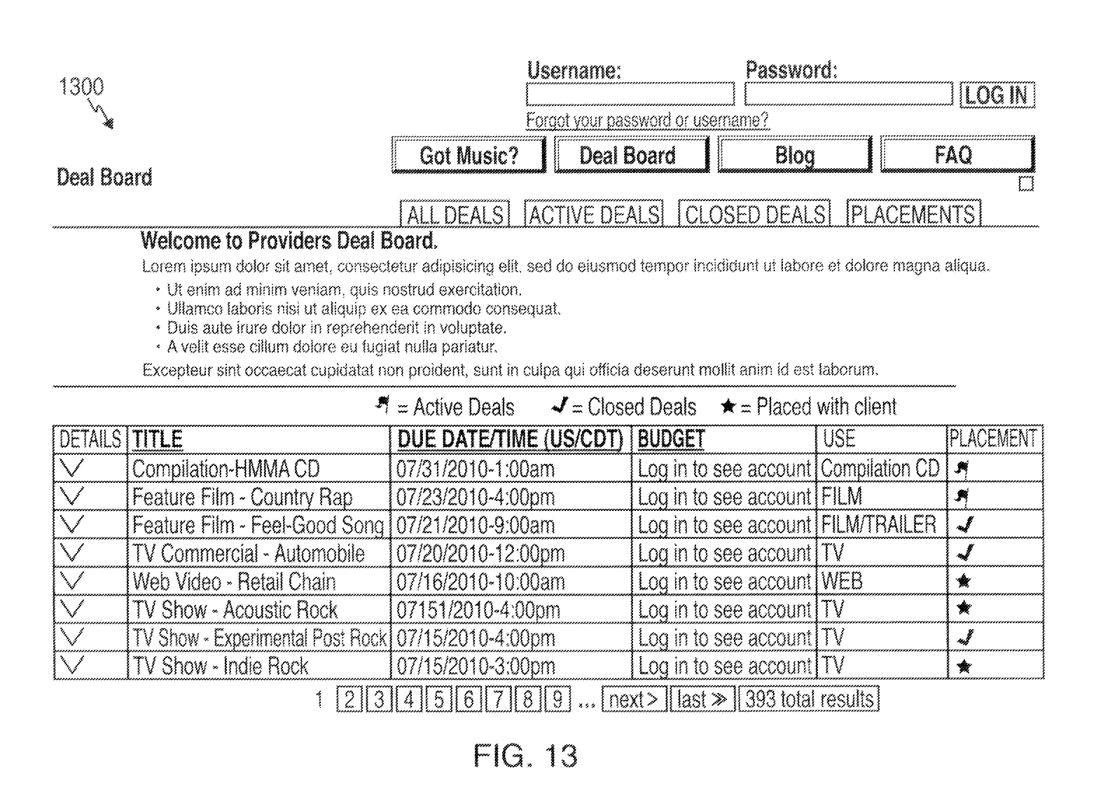

FIG. 13 illustrates a screen shot of a deal board on a provider's website. A provider's deal board may be provided to show the status of, and information relating to, active and closed deals carried out in connection with the system 100. In addition artists may submit songs in response to any such pending deals identified on the deal board. For example, a potential licensee may submit a request to provider for a “feel good” patriotic americana song, with female vocal type and a summer vocal theme, for use in connection with a commercial for novelty ice cream products. The provider may send a submission request via an email blast to all artists with this information, as well as post the deal as an “active deal” on the deal board. Artists may then submit songs that they believe fit the requirements of the submission request. Songs collected in response to the submission request may each be tagged with the particular deal name or submission request, and a provider personnel may then review the submitted songs (as well as any other songs in the system) to come up with a playlist for the requester.

Each of the deals posted on the deal board may include general information, such as the title of the request, the date/time the request was posted, the budget for the request, the intended use of the requested work (e.g., compilation CD, film, trailer, web or TV), and the status of the request (or “placement”). The status may state that it is an active request, closed deal, or the work has been placed with the requestor. As with the playlists and search module results list, each deal in the list of submission requests may include a “details” link to allow a viewer to expand the deal to provide more details.

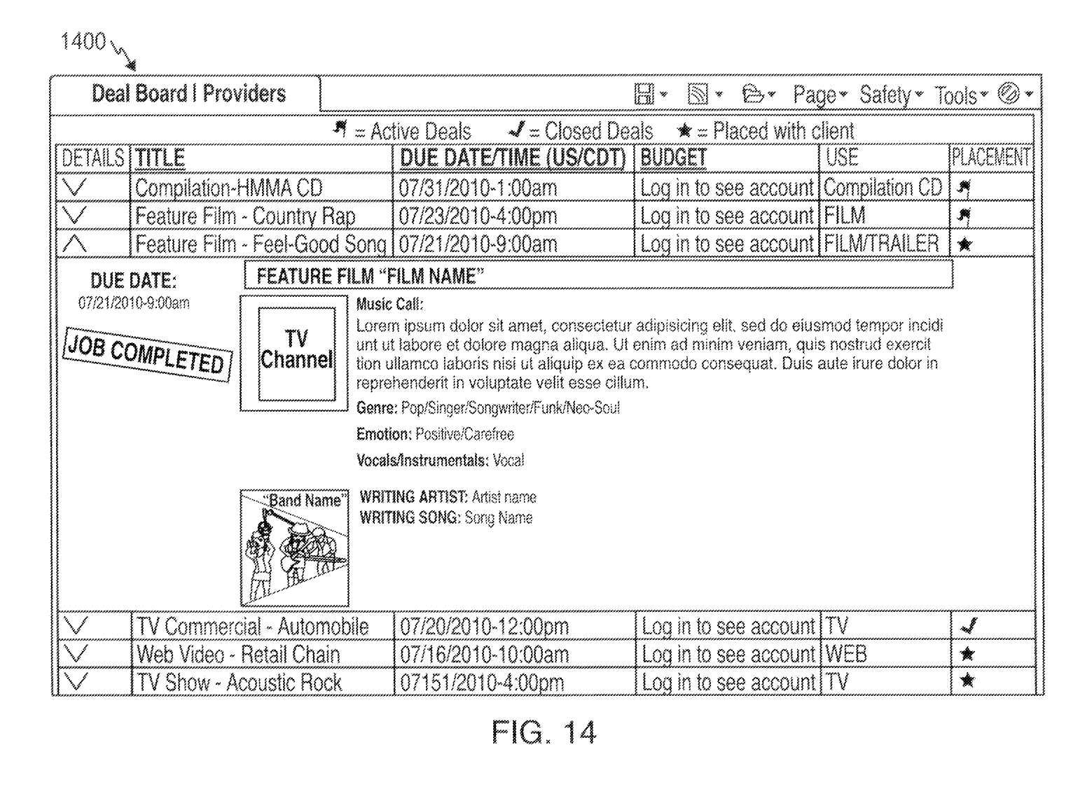

FIG. 14 illustrates a portion of the deal board of FIG. 13 with one of the deals in the list expanded to show details about the deal. As shown in FIG. 14, the additional details may include a due date, status (“Job Completed”), a description of the particular request (“Music Call”), the name and/or logo of the requestor, the genre and emotion of the song being requested, and whether a vocal or instrumental song is being sought. In the case where the deal has been closed and/or placed with the requestor, the winning artist/song may be provided, along with a link to the song on the server to allow the viewer to listen to the winning song. In an embodiment where email blasts are sent out relating to submission requests, such email blasts may be sent upon the submission request being posted, when the placement or status of any submission request changes, or any other change or modification to one or more of the pending submission requests.

FIG. 15 illustrates an example of an artist profile 1500. The artist profile may include the artist's name, a list of the artist's songs, with each song having a link to play the song, and a description relating to the artist and/or its music. Each song in the song list on the artist profile 1500 may have an option to expand the details to allow viewers to view the more detailed information (which may include genre, mood, keywords, duration, and other relevant information relating to the song). The artist profile 1500 may also include a link to the artist's past and upcoming shows.

Generally (though not necessarily) after an artist profile is created, an artist 106 may upload songs into the music database 120. In a preferred embodiment, the songs would not appear immediately on the artist's profile, rather it would appear after the song has been approved or “vetted” as described below. Alternatively, the song may be listed in the artist's lists of songs but remain unavailable for listening to until approved or vetted by the provider. When the song is uploaded, the artist 106 would include his or her own proposed tags or attributes for the song. In addition, the artist 106 may include requested rights information that may be cross referenced by the provider to ensure that the song is clear of any other third party rights for licensing use. The rights information may include information as to the artist's affiliation with any music labels, music publishers, or performance rights organizations (such as ASCAP, BMI or SESAC).

The process of FIG. 1B preferably includes a vetting and approval process 170 so as to facilitate licensing to members through a provider network. Generally, reviewers carry out the vetting and approval upon review of the songs so that when the songs are classified and included in the database 150, the vetting and approval process is completed before allowing the songs to be offered up for licensing purposes. Approval or vetting of a song in one implementation of the invention may include one or more of the following factors: (1) ensuring that the aural quality of the song as uploaded is acceptable, (2) ensuring the copyright rights in the song is free from all or certain encumbrances (e.g., submission of a cover or samples), and (3) ensuring that no other predetermined reasons exist that make the song unacceptable for submission. For example, a provider may not accept any songs with a digital rights management signature or “water mark.” While the approval or vetting has been described as being conducted by the provider, this process may alternatively be provided by a third party retained by or on behalf of the provider.

In one embodiment, the provider may implement strict procedures to ensure that songs included in the music database are clear for licensing use, and some or all of these procedures may be carried out at any time. In one implementation of a clearance procedure, one or more provider personnel (referred to as researchers) may be assigned to research all or any subset of songs in, or coming into, the music database 120. The researchers may each be assigned or select certain songs or playlists to clear at any given time. A queue of songs and playlists may be provided wherein the songs/playlists are sorted in order of importance or urgency. Alternatively, a single director may determine independently the order of priority in which the songs/playlists are cleared under the clearance procedures.

The researchers preferably run any number of searches and conduct other research in connection with his/her clearance of a song. In a preferred embodiment, the researcher will cross-reference the rights information provided by the artist 106 in connection with the song with existing known databases (e.g., information relating to affiliations with any music labels, music publishers, or performance rights organizations such as ASCAP, BMI or SESAC). The researcher may also research information relating to a music label or publisher identified by the artist, such as at www.allmusic.com, or www.wikipedia.com, www.last.fm, and www.discogs.com. Initially, a researcher is assigned to confirm that the song is free and clear of any major publishing conflicts, at which point the song may be given approval status to be reviewed by the reviewer.

Subsequent to initial approval, a song may be re-cleared in connection with its use on a playlist. When a playlist is populated, it may be sent to the provider's researcher department to be checked/verified for possible placement use. Even though the songs on the playlist have been previously cleared, it may be desirable to double check the songs before being sent to or used by a customer/recipient.

In one embodiment, a licensing research document may be created to keep track of and update the clearance research being done by provider. The licensing research document may be a spreadsheet with a number of relevant fields, including: Artist name, Removed from Licensing Contention?, Flag, Playlist Inclusion, Status Notes, Uploader Contacted?, Contact Reply Content, Artist Performance Rights Organization. The “Flag” in particular may be identified by a flag system that includes different levels of flags. For example, a red flag may require immediate attention or indicate that a song must be removed from the database; an orange flag may indicate a potential important discrepancy; a yellow flag may indicate a likely benign discrepancy; and a green flag may indicate final clearance. In addition, a 5^{th} flag (e.g., pink) may be available to identify a song corresponding to an artist that no longer exists in the provider's system. Obviously the use of a flag as an icon and/or the colors of the flags are merely a matter of design choice.

In accordance with an embodiment of the invention, the system 100 may further provide the ability for members 104 to obtain a license to one or more songs within the music database 120. In a typical scenario, an individual may select one or more songs from a playlist created by or on behalf of the user, such as for a particular job or project. Once the song is selected, the user communicates to provider the desire to obtain a license to the song. Such communication may be manually, such as by email or a phone call to provider. In addition or alternatively, the playlist may include, in the menu options or details for each song, a “License” option 425 where a user may obtain information on license terms, and/or execute the purchase of license rights under such license terms. Such purchase option may be accomplished via an ecommerce page that accepts payment information and provides confirmation of purchase. However the license is obtained, a provider licensing agreement would generally first be entered into between the provider and the artist 106, allowing the provider to then sublicense the artist's songs according to the license terms of the particular song. Other ownership and licensing scenarios may work within the present invention.

In some embodiments, songs may be classified in the music database with license-related tags. For example, a song may be classified based on the status of the licensor in the provider's network (e.g., “premium” or “standard”, where a premium artist may have a different contractual agreement with the provider than a standard artist). Songs may also be classified by their term of use (e.g., annual, monthly, single project, etc.). Also, songs may be classified according to any restrictions or exceptions to their use by a licensee. For example, an artist licensor may exclude his/her songs from being used in connection with—pornographic content, web-based media, or certain retailers. As another example, a song may be classified based on the type of license (e.g., exclusive, non-exclusive) or the fee at which the song is being licensed.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for facilitating the selection of music comprising:
a provider network having a first system interface, a second system interface, and a server, wherein the first and second system interfaces are operably connected to the server;
a music database associated with the provider network containing a plurality of songs; and
a playlist stored in association with the provider network, the playlist populated with one or more songs selected from the music database via the first system interface, wherein the provider network is configured to allow substantially simultaneous accessed to the playlist by the first and second user interfaces;
wherein the playlist provides notice to the second user interface of modification made to the playlist via the first user interface.

2. The system according to claim 1 further comprising a search module configured to search the music database and provide a resulting list of songs associated with a first classification, and means for selecting a first song from the resulting list of songs to populate the playlist via the first system interface.

3. The system according to claim 2 wherein the first classification is selected from the group consisting of vocal, instrumental, genre, secondary genre, mood, vocal type, explicit lyrics, instrument, keyword, description, vocal theme, language, beats per minutes, duration, time signature, key, era, artist, song title, and album title.

4. The system according to claim 3 wherein the resulting list of songs is associated with a second classification.

5. The system of claim 4 wherein the first classification is genre, and the second classification is selected from the group consisting of: americana, blues, cajun zydeco, children, classical, comedy, country, disco, easy listening, electronic, exotica, fanfares, marches, folk, funk, holiday, special occasion, international, jazz, latin, lounge, new age, pop, reggae, religious, rock, singer-songwriter, solo instrument, spoken word, urban, and world beat.

6. The system according to claim 1 further comprising an artist database containing a first artist profile, and means for selecting a first song from a list of songs in the first artist profile.

7. A system for facilitating the selection of music comprising:
a provider network having a first system interface, a second system interface, and a server, wherein the first and second system interfaces are operably connected to the server;
a music database associated with the provider network containing a plurality of songs;
a playlist stored in association with the provider network, the playlist populated with one or more songs selected from the music database via the first system interface, wherein the provider network is configured to allow substantially simultaneous accessed to the playlist by the first and second system interfaces; and
means for creating a customized visual appearance for the playlist via the provider network.

8. The system according to claim 7 further comprising means for providing access to the customized playlist to a third party via a third system interface.
